(19) United States
(12) Patent Application Publication
(10) Pub. No.: US 2006/0231487 A1
(43) Pub. Date: Oct. 19, 2006

(54) Coated filter media

(76) Inventors: Stuart L. Bartley, Lakewood, OH (US); Richard Yodice, Mentor, OH (US)

Correspondence Address: Teresan W. Gilbert;The Lubrizol Corporation, Patent Dept./Mail Drop 022B, 29400 Lakeland Blvd., Wickliffe, OH, 44092-2298, US

(21) Appl. No.: 11/105,260

(22) Filed: Apr. 13, 2005

(51) Int. Cl. B01D 39/00

(52) U.S. Cl. 210/506; 210/500.21; 55/524; 96/11

(57) ABSTRACT

The invention relates to a coating composition on the surface of a filtration media. In particular, the invention relates to a coating composition for a filtration media comprising at least one polymer; at least one crosslinking agent; and optionally at least one compatabilizing agent.

### FIELD OF THE INVENTION

The present invention relates to modified filter media, a process to make the modified filter media and the use of the modified filter media in filtration such as a bag, cartridge calendaring and the like.

### BACKGROUND OF THE INVENTION

The function of a filter is the removal of contaminants from a fluid such as water, oil, emulsions and air. Filtration can be achieved by different mechanisms. A filter membrane/sheet can be used to remove contaminants; i.e., particulate matter by mechanical sieving wherein particles larger than the pore diameter of the filter are removed. By this mechanism filtration efficiency is dependent upon the relative size of the contaminant and filter pore diameter. It is difficult to remove very small particles; i.e., less than 0.1 microns in diameter because it requires a filter with a very small pore size, and these filters tend to plug due to binding of the pores with large particles. This leads to increased pressures, slow filtration and early filter replacement.

Further, it is difficult to attach coatings/films to filter medias in particular polypropylene and thus, coated filter media results in poor filtration of contaminants.

The present invention provides a surface coating on a filter media.

Further, the invention provides a chemical modification of a filter media using a formulated polymer solution.

The invention further provides for a surface coating on a filter media that removes contaminants more effectively and efficiently compared to an uncoated media.

### SUMMARY OF THE INVENTION

The invention relates to a coating on the surface of a filtration media. In particular, the invention relates to a coating composition for a filtration media comprising 1) at least one reactive polymer; 2) at least one crosslinking agent; 3) optionally at least one compatabilizing agent comprising a reactive protecting group to prevent crosslinking in solution, and 4) optionally at least one component selected from the group consisting of latexes, binders, sizing resins, antioxidants, metal sequestering agents, corrosion inhibitors, slow release agents, soluble metal removal agents, biocides and mixtures thereof.

The invention further relates to a step-wise process to apply the coating on a filter media comprising 1) depositing at least one reactive polymer on a surface of a filter media which may optionally be mixed with a compatibilizing agent 2) adding a crosslinking agent on the surface of the filter media which contains the deposited reactive polymer 3) heating, evaporating and/or curing the components at a temperature in the range of about 25° C. to about 150° C. from about one minute to about 1000 minutes, resulting in a coated filter with improved adhesion to the surface of the media and improved ability for filtration.

In another embodiment the invention further relates to another process to apply the coating on a filter media by mixing and reacting a reactive polymer and a compatabilizing agent together and then adding the crosslinking agent to the mixture resulting in a coating solution and then apply the coating solution to the media by any method such as dipping, spraying, vacuum pull through and the like, and then drying the applied coating solution on the media at a temperature in the range of ambient temperature to about 150° C. resulting in a coated filter.

The coated filter media improves the effectiveness and efficiency of the removal of contaminants from fluids. Further, the coated filter media increases the effectiveness of the removal of small particles from the fluids without causing a noticeable increase in pressure while maintaining a flow rate of a larger pore filter. Additionally, small particles are removed effectively in the filtration process before cake filtration occurs while larger particles are still being trapped without noticeable clogging of the filter.

### DETAILED DESCRIPTION OF THE INVENTION

The invention relates to a novel coating composition for a filter, as well as a novel coated filter media to remove contaminants from fluids.

The novel coating comprises at least one reactive polymer, a crosslinking agent, optionally a compatabilizing agent and other optional components such as binders, latexes, sizing compounds, antioxidants, metal sequestering agents, corrosion inhibitors, slow release agents, soluble metal removal agents, biocides and mixtures thereof.

The reactive polymer is any hydrocarbon backbone with functional groups that can react with the crosslinking agent. In an embodiment preferably the reactive polymer contains reactive acids and acid anhydrides and their derivatives thereof. The reactive polymer further contains carboxylic acid or carboxylic anhydride groups such as 1) polyacrylic acid and polymers containing acrylic acid, 2) copolymers of olefin and maleic anhydride, 3) copolymers of styrene and maleic anhydride, 4) polyolefins reacted with maleic anhydride and 5) vegetable oils reacted with maleic anhydride.

The reactive polymer further includes:

1. Polymers containing maleic anhydride and related cyclic anhydrides, Maleic anhydride styrene copolymers (MSC), (also called styrene maleic anhydride copolymer or SMA), maleic anhydride/styrene/acrylate and methyl methacrylate tertpolymers, polyoctadecyl maleic anhydride (PODMA), partial esters of PODMA or MSC, succinated olefin copolymers (OCP), succinated polypropylene, succinated polyethylene, succinated polyisobutylene, succinated isoprene/isobutylene copolymers, maleic anhydride/alpha olefin copolymers poly (maleic anhydride-alt-1-octadecene), polymaleic anhydride-alt-1-tetradecene), poly(isobutylene-alt-maleic anhydride), poly(ethylene-alt-maleic anhydride), poly(ethylene-co-ethyl acrylate-co-maleic anhydride), poly(acrylic acid-co-maleic acid), polyolefins-graft-maleic anhydride, partial MSC-esters and PODMA-esters, partial esters of a maleic anhydride copolymer, a malan/styrene copolymer (1:1) such as Scripset available from Hercules; MW=350,000, maleic anhydride derivatives, and the like;

2. Polyacrylic acids; polyacrylates; copolymers of polyacrylic acid and polyacrylate; polylactic acid and derivatives, polyacrylonitriles, polyacrylamides, and the like;

3. Molecules containing two or more carboxylic acid groups and derivatives thereof, such as acid anhydrides, citric acid, adipic acid, pyromellitic dianhydride, ethylene tricarboxylic acid and the like;

4. Functionalized vegetable oils and derivatives thereof, and the like;

5. Polymers containing sulfonic acid monomers such as 2-acrylamido-2-methylpropane sulfonic acid, styrene sulfonic acid, and the like;

6. Polymers containing epoxides such as polybutadiene epoxy/hydroxyl functionalized, poly [(phenyl glycidyl ether)—co-formaldehyde] and related epoxides, and the like; or

7. Mixtures thereof.

In one embodiment, the preferred reactive polymer includes:

1. Polymers containing maleic anhydride and related cyclic anhydrides, Maleic anhydride styrene copolymers (MSC), (also called styrene maleic anhydride copolymer or SMA), maleic anhydride/styrene/acrylate and methyl methacrylate terpolymers, polyoctadecyl maleic anhydride (PODMA), PODMA MSC partial esters, succinated olefin copolymers (OCP), succinated polypropylene, succinated polyethylene, succinated polyisobutylene, succinated isoprene/isobutylene copolymers, maleic anhydride/alpha olefin copolymers poly (maleic anhydride-alt-1-octadecene), polymaleic anhydride-alt-1-tetradecene), poly(isobutylene-alt-maleic anhydride), poly(ethylene-alt-maleic anhydride), poly(ethylene-co-ethyl acrylate-co-maleic anhydride), poly(acrylic acid-co-maleic acid), polyolefins-graft-maleic anhydride, partial MSC-esters and PODMA-esters, partial esters of a maleic anhydride copolymer, a malan/styrene copolymer (1:1) such as Scripset available from Hercules; MW=350,000, maleic anhydride derivatives, and the like;

2. Polyacrylic acids; polyacrylates; copolymers of polyacrylic acid and polyacrylate; polylactic acid and derivatives, polyacrylonitriles, and the like; and

3. Malenated vegetable oil, carboxylated vegetable oil, vegetable oils and derivatives thereof, pyromellitic dianhydride, ethylene tricarboxylic acid, and the like, or

4. Mixtures thereof.

The reactive polymer can be used alone or in combination thereof.

The reactive polymer is in the range of about 1% to about 99%, in one embodiment in the range of about 5% to about 95% and in another embodiment in the range about 25% to about 75% of the total weight of the dry coating composition.

The reactive polymer may be used in a solution of an organic solvent, mineral or vegetable oil, aqueous solution, water in oil or oil in water emulsion and the like. Generally, the reactive polymer is used in a solution as opposed to being applied in a dry form. The choice of solution is determined by the desired properties and application properties of the coating and/or coated filter. The solution selected depends on the desired solubility, coatability, coating uniformity, coating distribution, compatabilization and the like. In one embodiment, the preferred solution is an aqueous solution.

The organic solvents for the reactive polymer solution include acetone, alcohols, aromatics such as toluene, xylene, and the like. The solvents may be used alone or in mixtures thereof.

The aqueous solution includes water, deionized water, impure water, and the like. Mixtures of aqueous solution may be used. Water with ionic species present like electrolytes, ammonia, mineral and organic salts, and the like can also be employed.

The reactive polymer is in the solution in a concentration in the range of about 0.01% to about 10%, in one embodiment in the range of about 0.05% to about 5% and in another embodiment in the range of about 0.1% to about 1% of the total weight of the reactive polymer solution.

The crosslinking agent reacts with the reactive polymer resulting in a bound polymeric network. This polymeric network enhances filtration efficiency of the coated filter media. The crosslinking agent contains two or more groups that are reactive with the appropriate portion of the reactive polymer. The crosslinking agent can include polyamines, with the formula NH₂CH₂CH₂(NHCH₂CH₂)nNH₂(n=0-1000), polyols which contain hydroxyl groups, mixed polyamine and polyols, other compounds with basic nitrogen groups and the like. The crosslinking agent further includes:

a. Amino acid polyamines, polyethylenimines such as the Lupasol materials available from BASF, polyamines such as diethylenetriamine (DETA), triethylenetetramine (TETA), tetraethylenepentamine (TEPA), pentaethylenehexamine (PEHA), amine bottoms and the like.; ethylenediamine; 1,3-diaminopropane; NH₂CH₂CH₂CH₂(NH₂CH₂CH₂CH₂)nNH₂CH₂CH₂CH₂NH₂ (n=0,1,2,3,4,5 etc), poly (allylamines), polyacrylonitrile reduce to amine, Jeffamines, Duomeens, hydrogenated polyacrylonitrile, polyaniline and oligomers, polypyrrole and oligomers, derivatives thereof and the like;

b. Polyols such as ethylene glycol, glycerol, diglycerol, triglycerol, neopentyl glycol, trimethylolpropane, ditrimethylolpropane, pentaerythritol, dipentaerythritol, tripentaeythritol, pentaeythritol ethoxylates, pentaerythritol proxylates, pentaerythritol ethoxylates/propoxylates, polycl, polyvinyl alcohols, polyvinyl acetate, sorbitol, alditols (mannitol, glucitol and the like), carbohydrates (polyhydroxy aldehydes and ketones) and the like;

c. Poly(ethylene glycols), poly(propylene glycols), and poly(ethylenepropylene glycols) and the like;

d. Alcoholamines such as ethanolamine, diethanolamine, triethanoplamine, 1,3-diamino-2-hydroxypropane, N,N′,N-tetrakis(2-hydroexyethyl)ethylenediamine, 2-2(2-aminoethoxy)ethanol, ethoxylated amines (Tomah), and the like;

e. Jeffamines such as Jeffamine D-230, D-400, D-2000, T-403 and the like; or

f. Mixtures thereof.

In one embodiment, preferably, the crosslinking agent contains hydroxyl or basic nitrogen groups.

The crosslinking agent may be used alone or in combination.

The crosslinking agent is in the range of about 1% to about 99%, in one embodiment in the range of about 10% to about 90% and in another embodiment in a range of about 25% to about 75% of the total weight of the dry coating composition.

The compatibilizing agent is used to solubilize the reactive polymer in the solution. In one embodiment the desired compatabilizing agent is determined for solubilizing the polymer in an aqueous solution. The compatabilizing agent is a volatile or labile compound that reacts with the reactive polymer to make it soluble or dispersible in the solution and prevents crosslinking with the crosslinking agent.

The compatabilizing agent includes ammonium hydroxide or other amines such as those with the formula NHxRy where x+y=3 R=methyl, ethyl and the like; NH₃: NH₄OH; water-soluble alkyl amines such as methyl amine, dimethyl amine, trimethyl amine, morpholine; piperidine, piperazine and the like; metal hydroxides such as LiOH, NaOH and KOH; NaHCO₃, Na₂CO₃, CO₂ and the like; (write out) hydroxylamine; hydrazines; borax; diammonium phosphate; potassium borate; sodium metasilicate; trisodium phosphate; and the like.

The compatabilizing agent may be used alone or in combination.

The compatibilizing agent is in the range of about 0% to about 90%, in another embodiment in the range of about 1% to about 50% and in another embodiment in the range of about 0.1% to about 20% of the total weight of the dry coating composition.

Optionally, other components can be used in the coating composition for the filter media. The optional components include fillers like talc and clays, binders, resins, latexes, acrylic latexes, sizing agents, antioxidants, metal sequestering agents, biocides, corrosion inhibitors, pigments, bleaching aids, slow release agents, removal of soluble metal agents and the like.

Exemplary optional components include polyacrylic latex emulsion binder systems like Hycar® 26391 which is heat-reactive, carboxy modified, aqueous, anionic dispersion of a copolymer based on acrylic esters., polyvinyl acetate latex binders, dry dispersible polyacrylic and polyvinyl acetate latexes, dimethylaminoethylamine, dimethylaminopropylamine, N,N,N′-trimethylethylenediamine, 2-mercaptoethylamine, 2-mercaptoethanol, metal ions and metal oxides, N,N-dialkylalkylamines, aminodiphenylamine, acid chloride of 2-acrylamido-2-methylpropane sulfonic acid, poly2-acrylamido-2-methylpropane sulfonic acid, polyvinylpyridine, polyanilines, polypyoles, tolytriazole, polyacrylates and chemically related compounds, other monomers and polymers, pigments like titanium dioxide and other inorganic pigments as well as organic pigments like phthalocyanines and the like.

The optional components may be used alone or in combination.

The optional component is in the range from about 0% to about 50%, in one embodiment in the range from about 2% to about 20% and in another embodiment in the range from about 0% to about 0.5% of the total weight of the dry coating composition.

The coating is made by reacting the reactive polymer preferably in solution, the crosslinking agent and the optional compatabilizing agent and/or the other optional components together to form a solution of the coating composition. The reaction occurs at a temperature in the range of ambient temperature to about 150° C., in one embodiment in the range of about 25° C. to about 100° C. and in another embodiment in the range of about 25° C. to about 80° C.

The invention further relates to a process to apply the coating on a filter media comprising 1) depositing at least one reactive polymer in solution on a surface of a filter media which may optionally be mixed with a compatibilizing agent 2) adding a crosslinking agent on the surface of the filter media which contains the deposited reactive polymer, 3) heating, evaporating and/or curing the components at a temperature in the range of about ambient temperature to about 150° C. from about one minute to about 1000 minutes, resulting in a coated filter with improved adhesion to the surface of the media and improved ability for filtration.

In another embodiment the invention further relates to another process to apply the coating on a filter media by using a filter media, in particular a non woven filter media, either synthetic, cellulosic or fiber glass or mixtures thereof, (a non woven filter media is generally made by starting with the appropriate fiber or pulp and then processing the fiber or pulp using binders, resins, fillers, pigments and other additives using techniques known to those skilled in the art of paper making) and then subsequently mixing and reacting a reactive polymer in solution and optionally a compatabilizing agent resulting in the coating solution and then apply the coating solution to the filter media i.e. non woven by any method such as dipping, spraying, vacuum pull through and the like, and then drying the applied coating solution on the media at temperature in the range of ambient temperature to about 150° C. resulting in a treated filter media.

In another embodiment the invention further relates to another process to apply the coating on a filter media by mixing and reacting a reactive polymer in solution and optionally a compatabilizing agent together with other optional components such as fillers, binders, latexes and/or sizing agents and then adding the crosslinking agent to the mixture resulting in the coating solution and then apply the coating solution to the media by any method such as dipping, spraying, vacuum pull through and the like, and then drying the applied coating solution on the media at temperature in the range of ambient temperature to about 150° C. resulting in a coated filter media.

The filtration media coated with the composition includes a) filtration fabric also known as “paper” or rolled goods; b) synthetic filtration fabrics often referred to as “non-wovens” such as polypropylene, polyethylene, polystyrene, and related polyolefins; fiberglass; polyamides such as nylon (6 and 6/6), Kevlar, Nomex; polyesters such as Dacron; polyacrylates, polymethacylates, polyacryonitrile such as Orion, polyvinyl chlorides and related materials, such as Saran; polytetrafluoroethylene; polyurethanes; copolymers of the above materials; and combinations thereof; c) natural filtration fabric such as cellulose and other paper-based filtration media paper; wool; cotton; fiber glass, carbon fibers; and combinations thereof; and d) metal filtration filters such as woven wire, perforated metal and sintered metals; granular solids (e) Woven fabric made from fibers such as cotton, nylon 6, polytetrafluorethylene (PTFE), nylon 6.6, nylon 11, nylon 12, halar (E-CTFE), polyester PBT, Polyester PET, polypropylene, acrylics, polyvinyl-den fluoride (PVDF), polyphosphate sulfide (PPS) and high density polyethylene. (f) filter aids such as adsorbents like diatomaceous earth, perlite, activated carbon, carbon black and related materials, anthracite, silicas, aluminas, and combinations thereof.

Combinations of filter media can be used.

The types of filters that are coated with the coating composition include filter pads, filter bags, filter cartridges, pleated filters, membrane filters, strainers, screens, candle filters, scintered metal filters, plastic filters, ceramic filters, filter presses, belt filters, rotary drum filters, leaf filters, plate filters, disc filters, “precoat filters”, a filter bed on a strainer element or support, air filters, and the like.

The coated filters are useful for the filtration of gases for the removal of solid contaminants which are exemplified by dirt particles, dust, SiO₂, Al₂O₃, Fe₂O₃, CaO, MgO, Na₂O, K₂O, TiO, clays, solid metal particles, carbon materials such as carbon black and activated carbon, particulates in industry, and combinations thereof, removal of odors, removal of toxic materials, and the filtration of other gases such as nitrogen, oxygen, carbon dioxide and the like, or flue gases, residual Hg, SO₃ and the like and combinations thereof and the filtration of aerosols, removal of acids (HIC, acetic acid, etc.),

Depending on the coating used the filters may be antibacterial and antiviral since the coated filter media may have a propensity for bacteria, pathogens and viruses due to the ionic nature of the coating.

The coated filter is useful for the filtration of liquids for the removal of water-insoluble contaminants such as solids contaminants which are exemplified by dirt particles, dust, SiO₂, Al₂O₃, Fe₂O₃, CaO, MgO, Na₂O, K₂O, tiO, clays, solid metal particles, carbon materials such as carbon black and activated carbon, particulates in industry, and combinations thereof. The coated filter is useful for the removal of liquid contaminants such as insoluble and non-miscible liquids such as aromatic compounds, hydrocarbons, halocarbons and combinations thereof. The coated filter is also useful for the removal of water-soluble contaminants such as water-soluble metal ions and metal oxides such as Hg, CU, H₃AsO₃, H3AsO₄, Pb, Cd, Ba, Be, Se, and the like; acids such as carboxylic acids, inorganic acids such as sulfuric acid), bases such as metal hydroxides, metal bicarbonates and carbonates; amines; soluble chemical contaminants such as amines, sulfur compounds, phosphorous compounds, unsaturated compounds, phenols, MTBE (methyl t-butyl ether), chlorocarbons (and other halocarbons); aromatic compounds such as phenols, alcohols, and the like; gases such as CO₂, SO₂, H₂S; odorous materials and combinations thereof. Furthermore, the coated filter on a filtration media is useful for the removal of fluid-insoluble particles contaminants such as by dirt (SiO2, etc.); wear debris in engines and machinery; as CaO particulates in the manufacture of detergents; carbon black and activated carbon in manufacturing such as in the pharmaceutical industry; soot and other carbon-based solids in engine oils and combinations thereof.

Advantages of a coated filter media are that the coated filter removes soluble metals from aqueous or solvent based solutions. Further, it increases the filtration efficiency of a filter media such as polypropylene for the removal of contaminants from air, water and from oil. The filtration efficiency is not significantly affected by the pH (for example pH 4-10) of the solution because the crosslinking groups employed are chemically unaffected by the broad pH range. The coated filter allows a larger-pore filter (about 10 um) to filter more efficiently than an uncoated, smaller-pore filter (about 5 um). The coated filter media improves the effectiveness and efficiency of the removal of contaminants from fluids. Further, the coated filter media increases the effectiveness of the removal of small particles from the fluids without causing a noticeable increase in pressure while maintaining a flow rate of a larger pore filter. Additionally, small particles are removed effectively in the filtration process before cake filtration occurs while larger particles are still being trapped without noticeable clogging of the filter.

### Specific Embodiment

### EXAMPLE 1

Coating solution preparation: Solution A was prepared by adding 300 g of Scripset 520 (from Hercules) to a container followed by 2502 g of distilled water. While mixing, 198 g of ammonium hydroxide (28%) was added. A hazy yellow slightly viscous liquid resulted. The final coating solution was prepared by adding 8 g of Lupasol Water Free (from BASF), 3056 g of distilled water, 56 g of ammonium hydroxide (28%) and 80 g of solution A.

The filter media of polypropylene was saturated with the final coating solution via dipping. The wet media was then partially dried in air to liberate the ammonia. The media was then placed in an oven at about 90° C. for at least 3 hours to finish drying and to cure the coating. The release of the ammonia allows for the crosslinking reaction between the SMA (styrene/maleic anhydride) and PEI (polyethylenimine) to occur. The dried media was then rinsed with water to remove any water soluble components. The media was dried and was ready for use. Data is given in Table 1 for the Mid America 25-72 polypropylene filter media coated with the coating solution. The coated media had a weight gain of 2.3-2.8 wt. %.

TABLE 1
Mid America 25-72 PP Filter Pad Coated with the Coating Solution

| | | Coated | Coating | % Weight |
|---|---|---|---|---|
| | Initial Weight | Weight | Weight | Coating |
| Sample | (grams) | (grams) | (grams) | Added |
| 1 | 2.7369 | 2.8002 | 0.0633 | 2.3% |
| 2 | 2.8986 | 2.9642 | 0.0656 | 2.3% |
| 3 | 3.0375 | 3.1094 | 0.0719 | 2.4% |
| 4 | 2.7649 | 2.8293 | 0.0644 | 2.3% |
| 5 | 2.4728 | 2.5418 | 0.069 | 2.8% |
| 6 | 2.4642 | 2.5337 | 0.0695 | 2.8% |

The data in Table 1 demonstrates that the coating amount can be measured as an increase in weight.

### EXAMPLE 2

Coated filter samples were tested in the filter rig against 3 grams of ISO Standard 12103-1 A3 medium test dust.

Four grades of test dust are designated in ISO 12103-1, a description of each is as follows: ISO 12103-1,A1 Ultrafine Test Dust is nominal 0-10 micron size. ISO 12103-1,A2 Fine Test Dust is nominal 0-80 micron size. A view of volume differential particle size data indicates a bi-modal distribution with approximate peaks at 4 and 20 micron size. ISO 12103-1,A3 Medium Test Dust is nominal 0-80 micron size with a lower 0-5 micron content than ISO 12103-1,A2 Fine Test Dust. ISO 12103-1,A4 Coarse Test Dust is nominal 0-180 micron size.

The test dusts used in our studies are sold under a variety of names: Arizona Road Dust, Arizona sand, Arizona Silica, AC Fine and AC Coarse Test Dusts, SAE Fine and Coarse Test Dusts, J726 Test Dusts, and most recently ISO Ultrafine, ISO Fine, ISO Medium and ISO Coarse Test Dusts., ISO 12103-A1 (ultra fine test dust), ISO 12103-A2 (fine test dust), ISO 12103-A3 (medium test dust), ISO 12103-A4 (coarse test dust), J726 Test Dust, Medium test dust and can be obtained by various vendors such as: Powder technology Inc., Reade Advanced Materials, National Institutes of Standards and technology.

In Table 2 is the data for the MidAmerica 25-72 filtration media (25 micron average pore diameter) coated with the Scriptset 520/NH₄OH/Lupasol WF/water solutions. Item 1 is the filter media without any coating; this collected only 23.4 wt % of the dust. Items 2-4 are the data for the filter pads coated with the Scriptset 520/NH₄OH/Lupasol WF/water solution at 0.25 wt %, 0.5 wt % and 0.75 wt % (actives based on Scripset 520 and Lupasol WF); all of these had a much greater efficiency (70-76%) for removing test dust.

TABLE 2
MidAmerica 25-72 PP Filter Media Coated with
Scripset 520/NH₄OH/Lupasol WF/water solution.
Filtration Studies Using ISO Standard 12103-1 A3 Medium Test Dust

| | % wt | | | | |
|---|---|---|---|---|---|
| | Acitives in | | Final wt | | |
| | Coating | Initial | (g) with | Dust Wt | |
| Item | Solution* | Wt (g) | Dust | (g) | % of 3 g |
| 1. | control | 2.4893 | 3.1923 | 0.7030 | 23.4 |
| 2. | 0.25 | 2.6914 | 4.811 | 2.1196 | 70.7 |
| 3. | 0.5 | 2.5410 | 4.6701 | 2.1291 | 71.0 |
| 4. | 0.75 | 2.8569 | 5.1431 | 2.2862 | 76.2 |

*Coating solution: Scriptset 520/NH₄OH/Lupasol WF/water (actives based on Scripset 520 and Lupasol WF.

### EXAMPLE 3

To a 600 mL beaker was added 0.5 g test dust and 500 g distilled water. The solution was mixed on a magnetic stirring plate. A sample was removed for initial particle count/size measurement using a Beckman-Coulter RapidVue 5× particle shape and size analyzer. The filter media (25 micron Mid-American polypropylene filter media (PO 25-72)) was treated with Scriptset 520/NH₄OH/Lupasol WF/water solution (0.5 wt % actives based on Scripset 520 and Lupasol WF). The filter media was placed in the dust solution at an angle as not to interfere with the stirring bar. The solution was stirred for 9 minutes and the final dust solution was analyzed

In Table 3 are given the particle analyses of the water-dust samples stirred with the media. The treated filter media removed a larger percentage of the particles and the untreated media removed only a very small percentage of the particles.

TABLE 3
Test Dust Removal Summary

| | Treated | Treated | Treated | | |
|---|---|---|---|---|---|
| | Ultrafine | Fine | Medium | Untreated | Fine |
| | Dust | Dust | Dust | Fine Dust | Corr. |
| % Particles removed | 86% | 86% | 82% | 1% | 85% |
| Removal Breakdown | | | | | |
| 2 < x < 5 microns | 86% | 84.2% | 80% | −3.4% | 88% |
| 5 < x < 10 | 86% | 90% | 84% | 5% | 85% |
| 10 < x < 20 | 87% | 95% | 86% | 33% | 62% |
| 20 < x < 50 | 83% | 99% | 85% | 64% | 35% |
| 50 < x < 80 | 77% | 94% | 91% | 20% | 74% |
| x > 80 | 65% | 90% | 59% | −38% | 127% |

### EXAMPLE 4

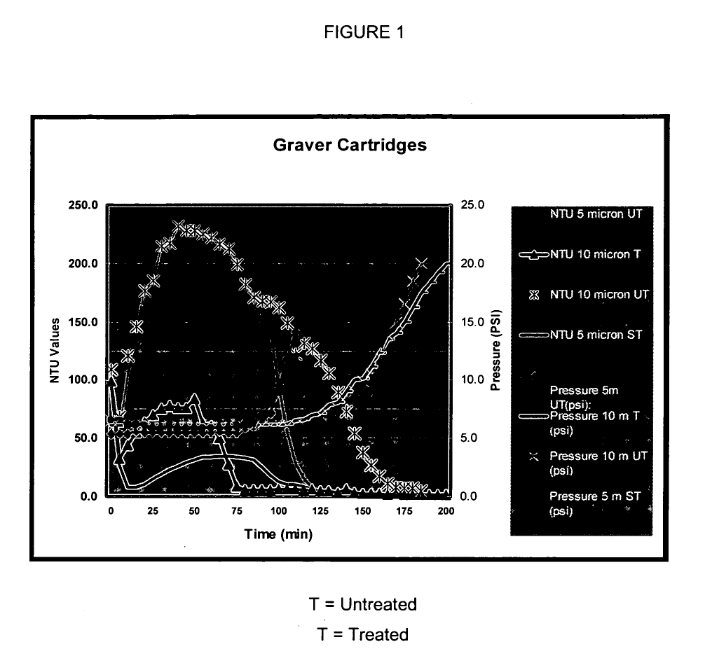

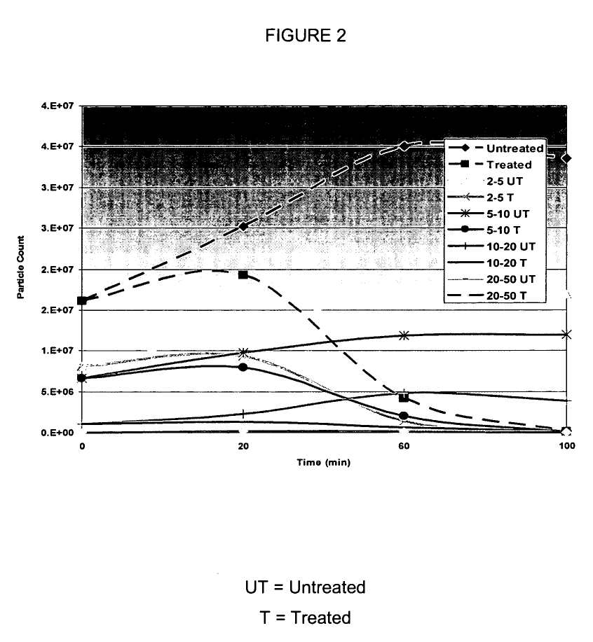

Graver cartridge filters (5 micron and 10 micron) were coated with a SMA/NH₄OH/Lupasol WF/water solution (0.25% wt actives based on SMA 5 and Lupasol WF). The coating was applied by pulling the solution through the filter by vacuum, air drying the filter at room temperature overnight, and then heating in an oven at 100° C. for 6 hours. The cartridges were placed in a filter assembly and tested. Initially, 2.5 g of test dust was charged into 2 gallons of water and this was passed through the filter in a multipass mode at 2 gallons per 10 minute. Subsequently, 2.5 g of test dust was added at each five-minute interval for a total test period of 180 to 200 minutes. As shown by the NTU values in FIG. 1, the coated cartridges were much more efficient than the uncoated cartridges in removing test dust from the water during the first 120 to 160 minutes of the test.

### EXAMPLE 5

Two GAF ABP-10 T2K bags were used for this experiment. One was treated by dip coating and drying in an oven overnight. The other bag was used as it was received. The experiment was done by passing distilled water through the bag in multi-pass arrangement at 2 gallons/minute for a period of 100 minutes. The reservoir held 2.5 gallons of water that was fed 20 grams of ultra-fin test dust every 20 minutes.

At the end of the test the reservoir continued 300 times more particulate in the untreated bag the than with the treated bag. The treated bag is 99.99% efficient at removing particles wile the untreated bag is 34.9% efficient under the test conditions.

The treated bag held 96% of the test dust compared to the untreated bag which held 46%.

### EXAMPLE 6

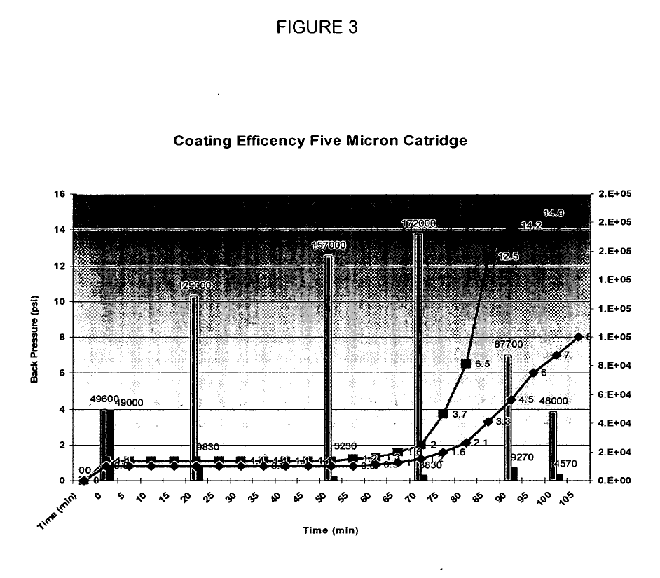

A Sears 5 um spunbond cartridge was placed in a filter assembly. A reservoir was filled with 2 gallons of distilled water and 1.6 g of medium test dust. The stirred water solution was circulated through the filter at a flow rate of 1 gallon per second. An additional 1.6 g of medium test dust was added to the reservoir every 5 minutes until the test was completed. Samples were removed from the filtered stream every 10 minutes and the particle sizes and counts were measured using a Coulter Particle Analyzer. These results are plotted in FIG. 3. The red (square) data points are the particles that pass through the untreated filter. The blue (diamond) data are the particles that pass through the treated filter. This data shows that the treated filter is more efficient at removing the test dust particles compared to the untreated filter. For the untreated filter, the particle counts remain high until the pressure increases. For the treated filter, the particles are removed earlier without a pressure increase. This shows that the untreated filter is not efficient until cake formation occurs and the treated filter is efficient from the outset at low pressures. At the 70 minute mark of the filtration studies, calibrating the particle count vs. grams test dust revealed 23% of total dust added remained in the reservoir for the untreated cartridge while 0.01% remained for the treated cartridge.

What is claimed:

1. A coating composition for a filter media comprising 1) at least one reactive polymer; 2) at least one crosslinking agent; 3) optionally at least one compatabilizing agent comprising a reactive protecting group to prevent crosslinking in solution, and 4) optionally at least one component selected from the group consisting of latexes, binders, sizing resins, antioxidants, metal sequestering agents, corrosion inhibitors, slow release agents, soluble metal removal agents, biocides and mixtures thereof.

2. The coating of claim 1 wherein the resulting coated filter media has characteristics selected from the group consisting of removal of contaminants from fluids; filters the removal of contaminants from air, water and from oil; removal of small particles from the fluids without causing a noticeable increase in pressure while maintaining a flow rate of a larger pore filter; removal of small particles in the filtration process before cake filtration occurs while larger particles are still being trapped without noticeable clogging of the filter; adhesions onto the surface of the filter media; removes soluble metals from aqueous or solvent based solutions; improved ability for filtration and combinations thereof.

3. The coating of claim 1 wherein the reactive polymer comprises a hydrocarbon backbone with functional groups that reacts with the crosslinking agent; the reactive polymer contains reactive acids and acid anhydrides and their derivatives thereof; the reactive polymer contains carboxylic acid or carboxylic anhydride groups selected from the group consisting of 1) polyacrylic acid and polymers containing acrylic acid, 2) copolymers of olefin and maleic anhydride, 3) copolymers of styrene and maleic anhydride, 4) polyolefins reacted with maleic anhydride and 5) vegetable oils reacted with maleic anhydride or mixtures thereof and wherein the reactive polymer is in the range of about 1% to about 99% of the total weight of the dry coating composition.

4. The coating of claim 1 wherein the reactive polymer comprises
a. polymers comprising maleic anhydride and related cyclic anhydrides, Maleic anhydride styrene copolymers (MSC), (also called styrene maleic anhydride copolymer or SMA), maleic anhydride/styrene/acrylate and methyl methacrylate tertpolymers, polyoctadecyl maleic anhydride (PODMA), partial esters of PODMA or MSC, succinated olefin copolymers (OCP), succinated polypropylene, succinated polyethylene, succinated polyisobutylene, succinated isoprene/isobutylene copolymers, maleic anhydride/alpha olefin copolymers poly(maleic anhydride-alt-1-octadecene), polymaleic anhydride-alt-1-tetradecene), poly(isobutylene-alt-maleic anhydride), poly(ethylene-alt-maleic anhydride), poly(ethylene-co-ethyl acrylate-co-maleic anhydride), poly(acrylic acid-co-maleic acid), polyolefins-graft-maleic anhydride, partial MSC-esters and PODMA-esters, partial esters of a maleic anhydride copolymer, a malan/styrene copolymer (1:1) such as Scripset 520 available from Hercules;, maleic anhydride derivatives or combinations there of;
b. polyacrylic acids; polyacrylates; copolymers of polyacrylic acid and polyacrylate; polylactic acid and derivatives, polyacrylonitriles, polyacrylamides, or combinations there of;
c. molecules containing two or more carboxylic acid groups and derivatives thereof, such as acid anhydrides, citric acid, adipic acid, pyromellitic dianhydride, ethylene tricarboxylic acid, or combinations there of;
d. polymers containing sulfonic acid monomers such as 2-acrylamido-2-methylpropane sulfonic acid, styrene sulfonic acid or combinations thereof;
e. polymers containing epoxides such as polybutadiene epoxy/hydroxyl functionalized, poly [(phenyl glycidyl ether)—co-formaldehyde] and related epoxides, or combinations thereof;
f. functionalized vegetable oils and derivatives thereof, or combinations there of; i.e malenated orcarboxylated vegetable oil, and derivatives thereof,
g. mixtures thereof.

5. The coating of claim 3 wherein the reactive polymer is used in a solution of an organic solvent, mineral oil, vegetable oil, aqueous solution, water in oil emulsion, oil in water emulsion or combinations there of and wherein the reactive polymer is in the solution in a concentration in the range of about 0.01% to about 10% of the total weight of the reactive polymer in solution.

6. The coating of claim 1 wherein the crosslinking agent reacts with the reactive polymer resulting in a bound polymeric network and wherein the crosslinking agent comprises two or more groups that are reactive with the appropriate portion of the reactive polymer and wherein the crosslinking agent is in the range of about 1% to about 99% of the total weight of the dry coating composition.

7. The coating of claim 1 wherein the crosslinking agent comprises polyamines, with the formula NH₂CH₂CH₂(NHCH₂CH₂)nNH₂(n=0-1000); polyols which contain hydroxyl groups, mixed polyamine and polyols, other compounds with basic nitrogen groups; amino acid polyamines, polyethylenimines such as the Lupasol materials available from BASF, polyamines such as diethylenetriamine (DETA), triethylenetetramine (TETA), tetraethylenepentamine (TEPA), pentaethylenehexamine (PEHA), amine bottoms and the like.;
ethylenediamine; 1,3-diaminopropane;
NH₂CH₂CH₂CH₂(NH₂CH₂CH₂CH₂)nNH₂CH₂CH₂CH₂NH₂ (n=0,1,2,3,4,5 etc), poly (allylamines), polyacrylonitrile reduce to amine, Jeffamines, Duomeens, hydrogenated polyacrylonitrile, polyaniline and oligomers, polypyrrole and oligomers, derivatives thereof; polyols such as ethylene glycol, glycerol, diglycerol, triglycerol, neopentyl glycol, trimethylolpropane, ditrimethylolpropane, pentaerythritol, dipentaerythritol, tripentaeythritol, pentaeythritol ethoxylates, pentaerythritol proxylates, pentaerythritol ethoxylates/propoxylates, polyvinyl alcohols, polyvinyl acetate, sorbitol, alditols (mannitol, glucitol and the like), carbohydrates (polyhydroxy aldehydes and ketones); poly(ethylene glycols), poly(propylene glycols), and poly(ethylenepropylene glycols); alcoholamines such as ethanolamine, diethanolamine, triethanoplamine, 1,3-diamino-2-hydroxypropane, N,N′,N-tetrakis(2-hydroexyethyl)ethylenediamine, 2-2(2-aminoethoxy)ethanol, ethoxylated amines (Tomah; Jeffamines such as Jeffamine D-230, D-400, D-2000, T-403; or mixtures there of.

8. The coating of claim 1 wherein the compatibilizing agent is used to solubilize the reactive polymer in the solution and the compatibilizing agent is in the range of about 0% to about 90% of the total weight of the dry coating composition.

9. The coating of claim 1 wherein the compatibilizing agent comprises ammonium hydroxide or other amines such as those with the formula NHxRy where x+y=3 R=methyl, ethyl and the like; NH_{3:} NH₄OH; water-soluble alkyl amines such as methyl amine, dimethyl amine, trimethyl amine, morpholine; piperidine, piperazine and the like; metal hydroxides such as LiOH, NaOH and KOH; NaHCO₃, Na₂CO₃, CO₂ and the like; (write out) hydroxylamine; hydrazines; borax; diammonium phosphate; potassium borate; sodium metasilicate; trisodium phosphate; or mixtures there of.

10. The coating of claim 1 wherein at least on component comprises polyacrylic latex emulsion binder systems characterized as heat-reactive, carboxy modified, aqueous, anionic dispersion of a copolymer based on acrylic esters, polyvinyl acetate latex binders, dry dispersible polyacrylic and polyvinyl acetate latexes, dimethylaminoethylamine, dimethylaminopropylamine, N,N,N′-trimethylethylenediamine, 2-mercaptoethylamine, 2-mercaptoethanol, metal ions and metal oxides, N,N-dialkylalkylamines, aminodiphenylamine, acid chloride of 2-acrylamido-2-methylpropane sulfonic acid, poly2-acrylamido-2-methylpropane sulfonic acid, polyvinylpyridine, polyanilines, polypyrroles, tolytriazole, polyacrylates and chemically related compounds, other monomers and polymers, pigments like titanium dioxide and other inorganic pigments as well as organic pigments like phthalocyanines or mixtures thereof and wherein the component is in the range from about greater than 0% to about 50% of the total weight of the dry coating composition.

11. The coating of claim 1 applied to a filtration media comprising a) filtration fabric, paper or rolled goods; b) synthetic filtration fabrics, non-woven fabrics, polypropylene, polyethylene, polystyrene, and polyolefins derivatives; fiberglass; polyamides such as nylon (6 and 6/6), Kevlar, Nomex; polyesters, Dacron; polyacrylates, polymethacyates, polyacryonitrile, Orlon, polyvinyl chlorides and related materials, Saran; polytetrafluoroethylene; polyurethanes; or copolymers of the above materials; c) natural filtration fabric, cellulose, paper-based filtration media paper; wool; cotton; fiber glass, carbon fibers; d) metal filtration filters, woven wire, perforated metal and scintered metals; or granular solids; (e) woven fabric made from fibers such as cotton, nylon 6, polytetrafluorethylene (PTFE), nylon 6.6, nylon 11, nylon 12, halar (E-CTFE), polyester PBT, Polyester PET, polypropylene, acrylics, polyvinyl-den fluoride (PVDF), polyphosphate sulfide (PPS) and high density polyethylene; (f) filter aids, adsorbents, diatomaceous earth, perlite, activated carbon, carbon black and related materials, anthracite, silicas, aluminas; or (g) combinations thereof.

12. The coating of claim 1 wherein the filter comprises filter pads, filter bags, filter cartridges, pleated filters, membrane filters, strainers, screens, candle filters, scintered metal filters, plastic filters, ceramic filters, filter presses, belt filters, rotary drum filters, leaf filters, plate filters, disc filters, precoat filters, a filter bed on a strainer element or support, air filters, or combinations thereof.

13. The coating of claim 1 wherein the coated filters are useful for the filtration of gases for the removal of solid contaminants which are exemplified by dirt particles, dust, SiO₂, Al₂O₃, Fe₂O₃, CaO, MgO, Na₂O, K₂O, TiO, clays, solid metal particles, carbon materials such as carbon black and activated carbon, particulates in industry, and combinations thereof, removal of odors, removal of toxic materials, and the filtration of other gases such as nitrogen, oxygen, carbon dioxide and the like, or flue gases, residual Hg, SO₃ and the like and combinations thereof and the filtration of aerosols, removal of acids, HIC, acetic acid, or mixtures thereof.

14. The coating of claim 1 wherein the coated filter is useful for the filtration of a) liquids for the removal of water-insoluble contaminants selected from the group consisting of solids contaminants, dirt particles, dust, SiO₂, Al₂O₃, Fe₂O₃, CaO, MgO, Na₂O, K₂O, tiO, clays, solid metal particles, carbon materials, carbon black, activated carbon, particulates in industry, and combinations thereof; b) liquid contaminants selected from the group consisting of insoluble and non-miscible liquids, as aromatic compounds, hydrocarbons, halocarbons and combinations thereof; c) water-soluble contaminants selected from the group consisting of water-soluble metal ions and metal oxides such as Hg, CU, H₃AsO₃, H₃AsO₄, Pb, Cd, Ba, Be, Se; acids, carboxylic acids, inorganic acids, sulfuric acid, bases, metal hydroxides, metal bicarbonates and carbonates; amines; soluble chemical contaminants, amines, sulfur compounds, phosphorous compounds, unsaturated compounds, phenols, MTBE (methyl t-butyl ether), chlorocarbons; aromatic compounds, phenols, alcohols, gases, CO₂, SO₂, H₂S; odorous and combinations thereof; d) fluid-insoluble particles contaminants selected from the group consisting of dirt (SiO2, etc.); wear debris in engines and machinery; as CaO particulates in the manufacture of detergents; carbon black and activated carbon in manufacturing such as in the pharmaceutical industry; soot and other carbon-based solids in engine oils and combinations thereof; or e) combinations thereof.

15. The coating of claim 1 wherein the coated filter media is not significantly affected by the pH (pH 4-10) of the solution.

16. The coating of claim 1 wherein the coated filter allows a larger-pore filter to filter more efficiently than an uncoated, smaller-pore filter.

17. A process to apply a coating on a filter media by mixing and reacting a reactive polymer and a compatabilizing agent together and then adding the crosslinking agent to the mixture resulting in a coating solution and then apply the coating solution to the media by a method selected from the group consisting of dipping, spraying, vacuum pull through and combinations thereof, and then drying the applied coating solution on the media at a temperature in the range of ambient temperature to about 150° C. resulting in a coated filter with improved adhesion to the surface of the media and improved ability for filtration.

18. A process to apply the coating on a filter media by using a non woven filter media selected from the group consisting of synthetic, cellulosic, fiber glass and mixtures thereof with binders, resins, fillers, pigments and other additives; and then subsequently mixing and reacting a reactive polymer in solution and optionally a compatabilizing agent resulting in a coating solution; and then applying the coating solution to the filter media by a method selected from the group consisting of dipping, spraying, vacuum pull through and combinations thereof; and then drying the applied coating solution on the media at temperature in the range of ambient temperature to about 150° C. resulting in a treated filter media.

19. A process to apply a coating on a filter media comprising 1) depositing at least one reactive polymer on a surface of a filter media which may optionally be mixed with a compatibilizing agent, 2) adding a crosslinking agent on the surface of the filter media which contains the deposited reactive polymer, 3) heating, evaporating and/or curing the components at a temperature in the range of about 25° C. to about 150° C. from about one minute to about 1000 minutes, resulting in a coated filter with improved adhesion to the surface of the media and improved ability for filtration.
